(19) United States
(12) Patent Application Publication
(10) Pub. No.: US 2007/0030294 A1
(43) Pub. Date: Feb. 8, 2007

(54) System and method for implementation of transition zone associated with an actuator for an optical device in a display system

(75) Inventors: Bryce Daniel Sawyers, Allen, TX (US); David Clark Hutchison, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/198,107

(22) Filed: Aug. 5, 2005

(51) Int. Cl. G09G 5/10

(52) U.S. Cl. 345/690

(57) ABSTRACT

System and method for the implementation of a transition zone associated with an actuator of an optical device in a display system. A preferred embodiment comprises determining a sub-frame transition time, initiating a sub-frame transition to coincide with a start of a spoke state of a color filter if the sub-frame transition time is less than or substantially equal to a duration of the spoke state, and spanning the sub-frame transition over the spoke state and a color state of the color filter if the sub-frame transition time is greater than the duration. The overlapping of at least a portion of the sub-frame transition with the duration of the spoke state can reduce the impact of the sub-frame transition on the image quality of the display system, since the display system is not displaying images during the spoke state.

### TECHNICAL FIELD

The present invention relates generally to a system and method for image display systems, and more particularly to a system and method for the implementation of a transition zone associated with an actuator of an optical device in a display system.

### BACKGROUND

It is possible to increase an effective resolution of a display system by performing a shift of an array of light modulators that is used to generate the images being displayed by the display system. Depending upon the configuration of the array of light modulators, one or more shifts may be needed to double the effective resolution. For example, if the array of light modulators is arranged in a diamond configuration, a single shift of the array can double the effective resolution. An array of size 1024×384 arranged in a diamond configuration can have the same effective resolution as a 1024×768 array with a single shift. If the array is arranged in a rectilinear configuration, three shifts of the array may be needed to double the effective resolution. Increasing the effective resolution of the array of light modulators can permit the use of a smaller and less expensive array while yielding the image quality of a larger array.

The array of light modulators for the display system, such as an array of light modulators using technologies such as positional micromirrors (digital micromirror devices (DMDs)), deformable mirrors, liquid crystal, and so forth, can be shifted optically. An optical lens (or mirror) can be mechanically moved in order to shift an image formed by the array of light modulators. The array of light modulators must be shifted for each frame being displayed. A time associated with the display of a frame is commonly referred to as a frame time.

One disadvantage of the prior art is that the shifting of the optical lens can take a finite amount of time. During this time, the display system is not properly displaying the image due to the optical lens not being in the proper location, therefore, if the shift takes too long, the image quality of the display system can degrade.

A second disadvantage of the prior art is that the shifting of the optical lens can occur at any time within a frame time without consideration being given to a weighting of the color being displayed. This can lead to blurring of the image in the color that is being displayed while the optical lens is being moved. Since the human eye is more sensitive to certain colors, if the shifting of the optical lens were to occur at times when visually sensitive colors are being displayed, then any image degradation would be more readily noticeable by viewers.

### SUMMARY OF THE INVENTION

These and other problems are generally solved or circumvented, and technical advantages are generally achieved, by preferred embodiments of the present invention which provides a system and method for the implementation of a transition zone associated with an optical actuator in a display system.

In accordance with a preferred embodiment of the present invention, a method is provided. The method includes determining a sub-frame transition time, and initiating a sub-frame transition to coincide with a start of a spoke state of a color filter if the sub-frame transition time is less than or substantially equal to a duration of the spoke state. The method also includes spanning the sub-frame transition over the spoke state and a color state of the color filter if the sub-frame transition time is greater than the duration of the spoke state.

In accordance with another preferred embodiment of the present invention, a method is provided. The method includes retrieving a light intensity to be displayed within a single frame with a light modulator, wherein the frame is made up of a plurality of sub-frames, and assigning the light intensity to a single sub-frame if the light intensity is less than or substantially equal to a minimum displayable amount of light in the frame. The method also includes dividing the light intensity by a number of sub-frames in the plurality of sub-frames and assigning the divided light intensity to each sub-frame in the plurality of sub-frames, if the light intensity is greater than the minimum displayable amount of light in the frame.

In accordance with another preferred embodiment of the present invention, a display system is provided. The display system includes a display device and a light distributor. The display device is coupled to a sequence controller and a memory, and displays image data stored in the memory. The light distributor is coupled to the sequence controller and the memory, and distributes a light value to be displayed within a frame substantially evenly across a plurality of sub-frames in the frame. The light value is part of the image data stored in the memory.

An advantage of a preferred embodiment of the present invention is that the shifting of the optical lens can be overlapped with portions of the frame time wherein no colors are being projected by the display system. Therefore, image quality of the display system is not degraded.

A further advantage of a preferred embodiment of the present invention is that if the shifting of the optical lens takes more time than the periods of no light transmission, the shifting of the optical lens can be timed to take place during portions of the frame time when colors that the human eye is not so sensitive to are being displayed.

Yet another advantage of a preferred embodiment of the present invention is that the display of colors in the frame time is distributed as evenly through the frame time as possible to enhance image smoothness and reduce flicker. This can result in an overall increase in the image quality of the display system.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1a and 1b are diagrams of an array of light modulators and the results of shifting the array of light modulators to increase the effective resolution of the array;

FIGS. 2a and 2b are diagrams of optical lens position in relation to frame and color filter timing for different optical lens movement frequencies, according to a preferred embodiment of the present invention;

FIG. 3 is a diagram of a color wheel, according to a preferred embodiment of the present invention;

FIGS. 4a through 4c are diagrams of techniques for reducing the impact of optical lens transition times on the image quality of a display system, according to a preferred embodiment of the present invention;

FIGS. 5a through 5c are diagrams illustrating possible distributions of light in a single frame period, according to a preferred embodiment of the present invention;

FIG. 6 is a diagram of a sequence of events in the implementation of an optical lens transition period in a display system, according to a preferred embodiment of the present invention;

FIG. 7 is a diagram of an algorithm for use in distributing light for display in a single frame of a display system, according to a preferred embodiment of the present invention; and

FIG. 8 is a diagram of a display system, according to a preferred embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a binary spatial light modulator (SLM) display system making use of a digital micromirror device (DMD) light modulator array. The invention may also be applied, however, to other SLM display systems, such as those making use of liquid crystal, liquid crystal on silicon, deformable micromirror, and so forth, light modulator arrays.

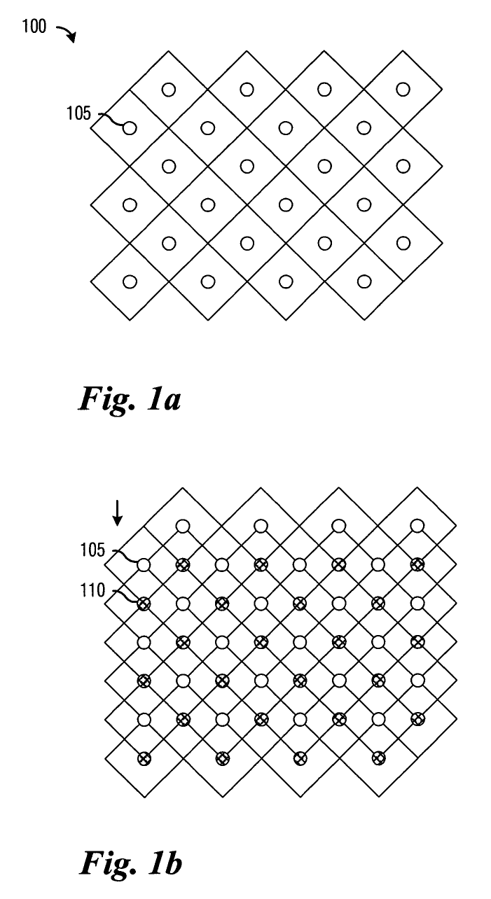

With reference now to FIGS. 1a and 1b, there are shown diagrams illustrating an array of light modulators 100 and the increased effective resolution of the array of light modulators due to a single shift. The array of light modulators 100, as shown in FIG. 1a, is arranged in a diamond configuration with dimension 8×3. Each light modulator in the array of light modulator 100, such as light modulator 105, is represented as a circular object. Each of the light modulators in the array of light modulators 100 can be representative of a positional mirror in a DMD, for example.

Due to the diamond shaped configuration of the light modulators in the array of light modulators 100, it is possible to effectively double the resolution of the array of light modulators 100 with a single shift. FIG. 1b illustrates the effect of a single, half light modulator sized shift in a downward direction with light modulators of the array of light modulators 100 prior to the shift being shown as unshaded circular objects and light modulators of the array of light modulators 100 after the shift being shown as shaded circular objects. The light modulator 105 becomes a new light modulator 110, for example. If the shift occurs with sufficient quickness, the human eye will not be able to notice the shift and the resulting image produced by a display system with the array of light modulators 100 that makes use of image shifting will have an effective resolution that is twice that of a display system with the array of light modulators 100 that does not make use of image shifting. As shown in FIG. 1b, an array of light modulators comprised of the array of light modulators 100 and the shifted array of light modulators has a resolution of 8×6. Although the shift is shown to be a shift in a downward direction, in practice, it is possible to shift the array of light modulators 100 in one of any number of directions and achieve the desired result. Therefore, the illustration of the downward shift should not be construed as being limiting to the spirit and scope of the present invention.

As discussed previously, the number of shifts of an array of light modulators needed to double the effective resolution of the array of light modulators can be dependent upon the configuration of the array. For example, if the light modulators are arranged in a rectilinear (orthogonal) configuration, three shifts will be needed to double the effective resolution of the array.

In order to increase the effective resolution an array of light modulators, and therefore the effective display of a display system, all necessary shifting of the array of light modulators must occur within a single frame time. A frame time is an amount of time allotted to the display of a single frame, for example, a typical frame time can be 1/60^{th} of a second or 16.67 milliseconds. While there is a minimum number of shifts of the array required to increase the effective resolution, image quality can be further improved, in terms of reduced flickering and increased smoothness, if additional shifts of the array can be performed within the frame time. For example, in an array with a diamond configuration, a single shift is required to double the effective resolution, however, if three shifts were to be performed (doubling the frequency of the shifts) within a single frame time, yielding two sub-frames in a position one of the optical lens and two sub-frames in a position two of the optical lens, the resulting image could have better smoothness and less flickering (although the same effective resolution).

However, since the shifts are performed by a mechanical actuator moving an optical lens, the shifts cannot occur instantaneously. Each of the shifts consumes a finite period of time that is dependent upon the physical characteristics of the actuator and of the optical lens. While the mechanical actuator is moving the optical lens, the display system can be displaying a part of the image. Since the optical lens is in motion, the image may not display properly and image blurring may result. Therefore, the timing of the transition, the duration of the transition, and the number of transitions within a single frame time all have an impact on the image quality of the display system.

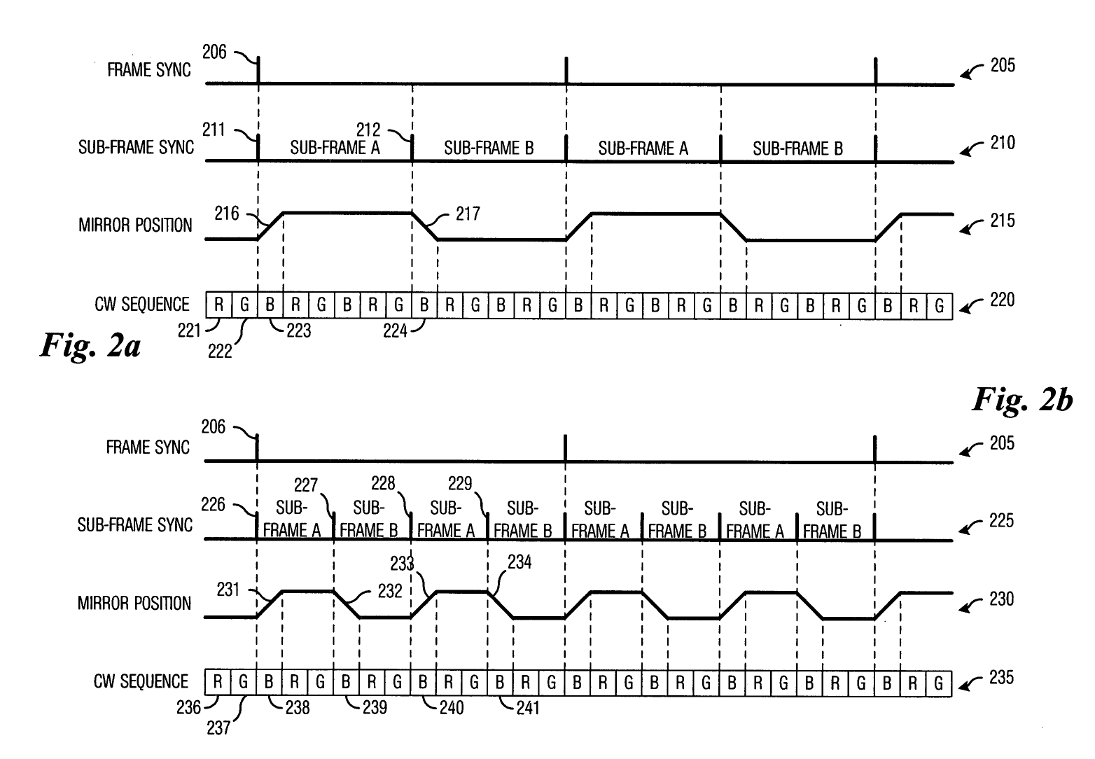

With reference now to FIGS. 2a and 2b, there are shown timing diagrams illustrating optical lens position (state) in relation to frame timing and color filter sequencing for display systems with two different optical lens movement frequencies, according to a preferred embodiment of the present invention. As shown in FIG. 2a, the optical lens of the display system shifts position twice within a single frame time, wherein the shifting of the optical lens can be achieved via the use of a mechanical actuator. Each shift of the optical lens can result in a change in the position and each unique position of the optical lens is labeled a sub-frame, either sub-frame A or sub-frame B in a display system where a single shift is required to double the effective resolution of the array. If the display system requires three shifts to double the effective resolution of the array, then there would be four unique sub-frames within the single frame time.

A first trace 205 displays a frame sync signal that can be used to provide synchronization pulses indicating a beginning (or an end) of frames. Periodically, a synchronization pulse is present on the frame sync signal, for example, sync pulse 206, and can be used as a marker of a beginning of a new frame. A second trace 210 displays a sub-frame sync signal that can be used to provide information indicating a beginning (or an end) of sub-frames. Since the display system makes use of an array of light modulators that requires a single shift to double the effective resolution of the array, within each frame period there are two sub-frames, the start of which are denoted by sub-frame sync pulses 211 and 212.

A third trace 215 displays optical lens position as a function of time. When a sub-frame sync pulse, such as the sub-frame sync pulse 211, appears on the sub-frame sync signal the mechanical actuator responsible for moving the optical lens can begin to move the optical lens from its current position to its subsequent position. Since there is inertia as well as friction present in the optical lens (as well as in the mechanical actuator itself), a period of time is required before the optical lens moves into the subsequent position. The movement of the optical lens is shown as transition 216. Another transition 217 illustrates the movement of the optical lens after the sub-frame sync pulse 212 appears on the sub-frame sync signal. The third trace 215 illustrates only an idealized representation of the optical lens position and does not show behavior such as ringing, vibrations, overshoot, and so forth.

A fourth trace 220 displays states of a color filter that can be placed in front of a wide-spectrum light source, such as an ultra high-pressure (UHP) arc lamp, to provide narrow-spectrum light. The UHP arc lamp provides a substantially white light, while for display purposes, light broken into components (such as red, green, and blue) is desired. The color filter, which for a display system with a DMD may be a wheel with colored wedges that spins radially, cycles through the color components and provides light of the component color that is currently in front of the light source. As shown in FIG. 2a, the color filter cycles through three component colors: red 221, green 222, and blue 223. The color filter remains in each state for a finite period of time, with the period of time being substantially equal for each component color, although it is not necessary that each state of the color wheel be given the same period of time. As shown in FIG. 2a, the transitions of the optical lens, such as transitions 216 and 217, can be timed to occur when the color filter is in certain states, blue 223 and 224, for example. Blue is typically chosen since the human eye has been shown to be least sensitive to the color blue. However, the transitions can occur while the color filter is in any state, and therefore, the illustration of the color filter being in the blue color state while the transition of the optical lens occurs should not be construed as being limiting to the scope and spirit of the present invention.

The timing diagram shown in FIG. 2a is from a display system with a single light source. There are display systems where there are separate light source for each of the component colors, for example, a display system can have a separate light source for each of the red, green, and blue component colors. Such systems typically do not make use of color filters since the individual light sources are producing light in the desired component colors. However, the remainder of the timing diagram shown in FIG. 2a may still be an accurate representation of the operation of the display system.

The diagram shown in FIG. 2b illustrates timing diagrams of optical lens position in relation to frame timing and color filter sequencing for a display system wherein the optical lens can assume one of two states but changes position four times within a single frame period, whereas the diagram shown in FIG. 2a illustrates timing relationships for a display system wherein the optical lens changes position two times within a single frame period. With more optical lens position changes within a single frame period and a substantially equal time period for each frame period between the two display systems, the optical lens in the display system shown in FIG. 2b will remain in a given position a shorter period of time. With an increased number of optical lens position changes, it is possible to obtain better display system image quality with less flickering and greater smoothness. However, with an increase in the number of position changes, there is a corresponding increase in the number of transitions, which can negatively affect the image quality of the display system if not properly handled.

A first trace 205 displays a frame sync signal that can be used to provide synchronization pulses indicating a beginning (or an end) of frames. Periodically, a synchronization pulse is present on the frame sync signal, for example, sync pulse 206, and can be used as a marker of a beginning of a new frame. A fifth trace 225 displays a sub-frame sync signal that can be used to provide information indicating a beginning of sub-frames. Since there are more sub-frames per frame period, the sub-frame sync signal is more active, indicating four sub-frame sync pulses 226, 227, 228, and 229 in a single frame period. A sixth trace 230 displays optical lens position as a function of time, with a mechanical actuator initiating a move of the optical lens with each sub-frame sync pulse. There is a finite amount of time required to move the optical lens from a first position to a second position, which is shown as a transition, such as transitions 231, 232, 233, and 234, between the first position of the optical lens to the second position of the optical lens.

A seventh trace 235 displays states of a color filter of the display system. As in FIG. 2a, the display system makes use of a color filter with three states (red, green, and blue) to provide narrow-spectrum light. The seventh trace 235 displays the sequence order of states of the color filter, beginning with a red 236, then a green 237, and followed by a blue 238. The transitions of the optical lens, such as transitions 232, 233, and 234, are aligned with blue states of the color filter, such as blue states 239, 240, and 241.

Although the alignment of the optical lens transitions with the color filter when it is in a state that is producing a light that the human eye is less sensitive to can reduce the visible image quality degradation in the display system due to the transition of the optical lens, image blurring in the color associated with the color filter state can still be noticeable if a significant portion of the color filter state time is occupied by the mirror transition times. According to a preferred embodiment of the present invention, a percentage of the optical lens transition time to a duration of the color filter state should be less than 40 percent in order to prevent unacceptable image blurring. Therefore, it may be more necessary to shorten the optical lens transition times in display systems where there are more transitions than in display systems where there are fewer transitions, for example, three transitions per frame period as opposed to one transition per frame period. However, since the transition time is dependent upon the physical capabilities of the mechanical actuator and the physical characteristics of the optical lens, it may not be possible to adequately shorten the transition time.

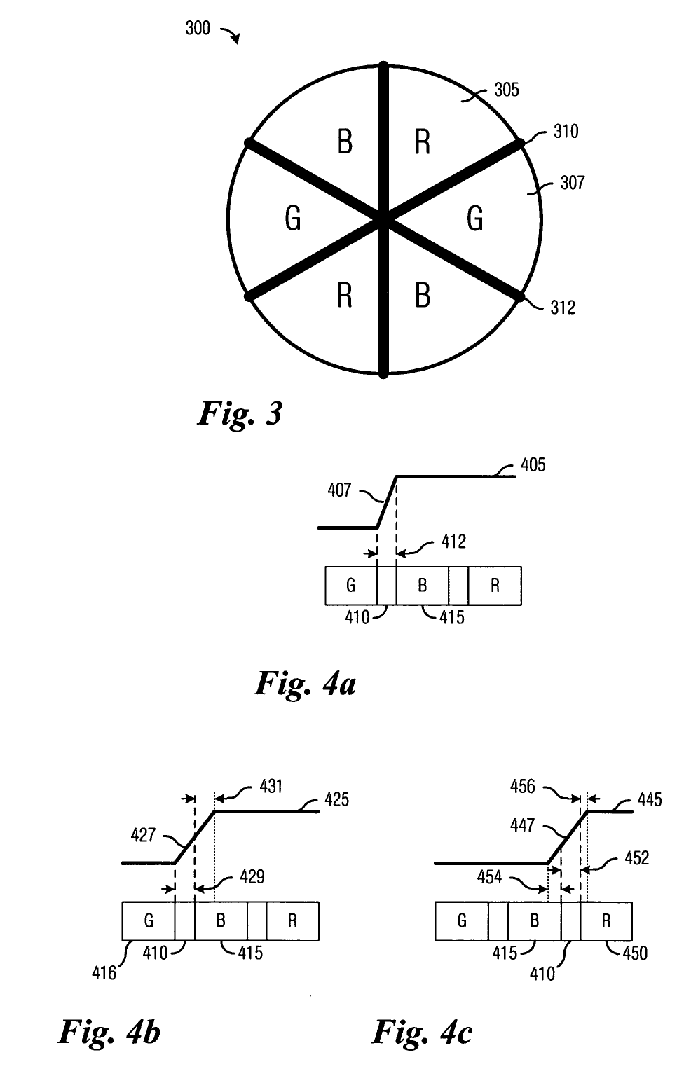

With reference now to FIG. 3, there is shown a diagram illustrating a color wheel 300 implementation of a color filter, according to a preferred embodiment of the present invention. The color wheel 300 can be placed between a light source and an array of light modulators (such as a DMD). The color wheel 300 comprises a plurality of colored filters, such as a red filter 305 and a green filter 307. The color wheel 300 contains at least one colored filter for each color component, for example, if it is desired to produce the three color components red, green, and blue, then a color wheel must have at least three colored filters, one for each of the color components. Separating the colored filters are spokes, such as spoke 310 separating colored sections 305 and 307 and spoke 312. A spoke can be used to account for timing uncertainties, such as an exact position of a color filter transition, for example.

A spoke can be an actual part of the color wheel 300 that is opaque in nature and therefore blocks transmission of light from the light source, or a spoke can be logical in nature and created by turning the positional mirrors in the DMD to an off position and then back to an on position. For example, in a display system wherein there are separate light sources for each one of the color components, a color wheel may not be necessary (since there is already light in each of the desired color components), however, it may still be necessary to logically create spokes by turning the positional mirrors on and off to facilitate the movement of the optical lens without scattering light or to account for timing uncertainties. Additionally, if a rapid switching light source, such a light-emitting diode (LED), a phosphor coated LED, a laser, and so forth, is used in the display system, rather than using the positional mirrors or the color wheel to create the spokes, the spokes can be created by turning the rapid switching light source off and then back on.

With reference now to FIGS. 4a through 4c, there are shown diagrams illustrating two techniques for reducing the impact of optical lens transition times on the image quality of a display system, according to a preferred embodiment of the present invention. If the optical lens transition time is less than or substantially equal to a spoke duration time, then the display system can be configured so that optical lens transition can occur while the color filter (color wheel) is in a spoke state. There is shown in FIG. 4a, a first trace 405 illustrating an exemplary transition 407 of an optical lens as a function of time and a portion of a sequence of color filter states, including a spoke 410 (with a duration shown as interval 412) and a blue state 415. As shown in FIG. 4a, the exemplary transition 407 has a duration that is substantially equal to the duration of the spoke 410. Therefore, it can be possible to overlap the exemplary transition 407 with the spoke 410 and not have any negative impact upon the image quality of the display system.

The diagram shown in FIG. 4b illustrates a situation wherein a second trace 425, displaying a transition 427 of an optical lens with a longer duration than a duration of a spoke 410 (with the duration shown as interval 429). Since the duration of the transition 427 is greater than the duration of the spoke 410 (interval 429), it is not possible to completely overlap the transition 427 with the spoke 410. However, if the display system can be configured so that the transition 427 can begin at substantially the same time as the beginning of the spoke 410, then a duration of the transition substantially equal to the duration of the spoke 410 can be overlapped with the spoke 410. Only a portion of the transition 427 that is not overlapped with the spoke 410 (shown as interval 431) will negatively impact the image quality of the display system. The negative impact on the image quality can be further mitigated by having the transition 427 while the color wheel 300 is in a state with relatively low human eye sensitivity, such as the blue state 415. An alternative to the diagram shown in FIG. 4b is possible where the transition 427 begins in a color state that precedes the spoke 410, such as the green state 416, and is timed so that the transition 427 ends at about the same time when the spoke 410 ends.

Even with overlapping the optical lens transition with the spoke state of a color wheel, the impact of the optical lens transition on a color component state of the color wheel may still negatively impact the image quality of the display system if the portion of the optical lens transition occurring within the color component state comprises a significant portion of the color component state, for example, if the interval 431 is a significant portion of the blue state 415, the image quality of the display system in the blue color can suffer. To reduce the overlap of the optical lens transition on a single color wheel state, it can be possible to span more than one color filter state with the overlap.

The diagram shown in FIG. 4c illustrates a situation wherein a third trace 445, displays a transition 447 of an optical lens with a longer duration than a duration of a spoke 410 (with the duration shown as interval 452). Since the duration of the transition 447 is greater than the duration the spoke 410 (interval 454), it is not possible to completely overlap the transition 447 with the spoke 410. The display system can be configured so that the transition 447 can begin at a time prior to the beginning of the spoke 410. As shown in FIG. 4c, the transition 447 begins prior to the start of the spoke 410, while the color filter is in a blue state 415, with a time that the transition 447 occurring with the color filter in the blue state 415 shown as interval 454. The duration of the transition 447 is greater than a sum of the intervals 452 and 454, therefore, a portion of the transition 447 will occur while the color filter is in a red state 450, with a time that the transition 447 occurring with the color filter in the red state 450 shown as interval 456. The transition 447 now spans two color filter states (blue state 415 and red state 450) and affects each to a lesser degree than would be the case if the transition 447 occurred only while the color filter was in one state.

The presence of multiple sub-frames within a single frame period can permit the ability to project light associated for a single portion of an image being displayed in a discontinuous manner. For example, in a display system with four sub-frames per single frame period, it may be possible to project all necessary light for the entire frame period within one of the sub-frames and then have no light for any of the remaining sub-frames. This can result in an image with flickering. Furthermore, it is possible to provide all of the necessary light for the entire frame period in multiple sub-frames wherein the optical lens is in a single position, for example, the necessary light can be projected only during sub-frames one and three with the optical lens in position one. This can result in an image that is not smooth since effectively 50 percent of the available resolution of the display system is not used. Therefore, light across sub-frames should be as evenly distributed as possible to reduce unsmoothing, flickering, and so forth.

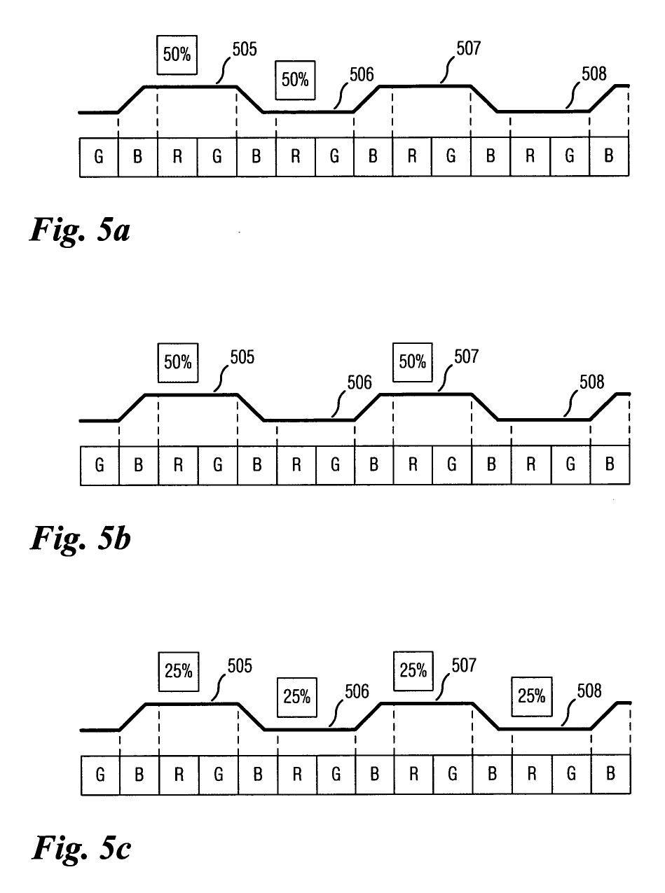

With reference now to FIGS. 5a through 5c, there are shown diagrams illustrating possible distributions of light in a single frame period, according to a preferred embodiment of the present invention. The diagrams shown in FIGS. 5a through 5c illustrate the distribution of red light in a single frame period, however, similar diagrams can be used to illustrate the distribution of other colors of light. The diagram shown in FIG. 5a illustrates the distribution of a red light equally (or substantially equally) in sub-frame one 505 and sub-frame two 506, with approximately 50 percent of the red light projected in sub-frame one 505 and approximately 50 percent of the red light projected in sub-frame two 506. No red light is projected in either sub-frame three 507 or sub-frame four 508. Since approximately half of the frame is not being used to project any red light, it may be possible to detect a flicker in the image, especially if there is a significant amount of red light being projected in sub-frames one 505 and two 506.

The diagram shown in FIG. 5b illustrates the distribution of a red light equally (or substantially equally) in sub-frame one 505 and sub-frame three 507. Since the optical lens can assume one of two positions (position one and position two), all of the red light is being projected while the optical lens is in one position (either position one or position two). Since only one optical lens position is being used to project the red light, half of the effective resolution of the display system is being wasted. Therefore, an “unsmooth” image can result due to the lost of half of the display system's resolution.

In order to display an image with reduced flickering and full use of the available display resolution of the display system, all sub-frames within a single frame period should be utilized. With the exception of the smallest amounts of light, which are on the order of the least amount of light displayable within a single sub-frame, it can be possible to distribute the light to be displayed within a single frame period equally (or substantially equality) between the sub-frames within the single frame period. The diagram shown in FIG. 5c illustrates the distribution of a red light equally (or substantially equally) in sub-frame one 505, sub-frame two 506, sub-frame three 507, and sub-frame four 508. With substantially the same amount of red light within each of the four sub-frames in the single frame period, flickering can be reduced as well as the full effective display resolution of the display system is being utilized.

The distribution of the light substantially equally across the sub-frames of a single frame period can be difficult with a display system that makes use of a light source that is permanently on, such as the case with a UHP arc lamp, since it is typically not easy to modulate the light produced by the light source except via the light modulators. However, if the display system uses a rapidly switching light source, such as an LED, phosphor coated LED, laser, laser diode, and so forth, the distribution of the light across the sub-frames can be readily accomplished since the degree to which it is possible to modulate the light produced by the rapidly switching light source can be much greater than with the permanently on light source. For example, not only is it possible to modulate the light with the light modulator, it is possible to modulate the light produced by the rapid switching light source by turning the light on and off within a sub-frame as desired as well as varying the intensity of the light produced by the light source.

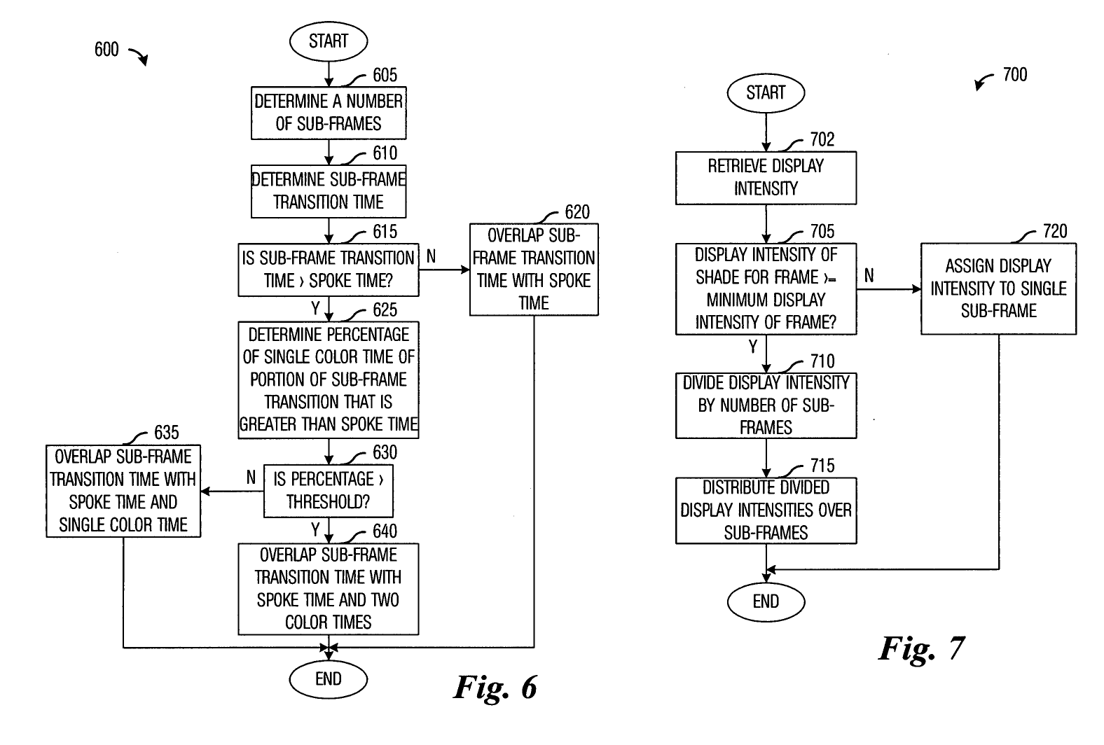

With reference now to FIG. 6, there is shown a diagram illustrating a sequence of events 600 in the implementation of an optical lens transition period in a display system to minimize impact on image quality, according to a preferred embodiment of the present invention. The sequence of events 600 can be descriptive of a sequence of events in the design of a display system that includes an optical lens that is used to optically shift an array of light modulators to increase the effective resolution of the display system. The sequence of events 600 focuses on the minimization of the impact of the transition of the optical lens on the overall image quality of the display system. The minimization of the impact of the transition of the optical lens on the overall image quality of the display system can take place during a design process of the display system.

The sequence of events 600 can begin with a determination (or specification) of a number of sub-frames per single frame period (block 605). The number of sub-frames per single frame period can be dependent on a variety of factors, such as a number of shifts of the optical lens required to increase the resolution of the display system, a desired amount of image smoothness, operating characteristics of a mechanical actuator used to move the optical lens, and so forth. After determining the number of sub-frames per single frame period, a sub-frame transition time can be determined (block 610). The sub-frame transition time can be the amount of time required to move the optical lens from a first position to a second position and can include time required to permit the optical lens to adequately stabilize. The sub-frame transition time can be dependent upon the physical capabilities of the mechanical actuator, as well as the physical characteristics of the optical lens.

Once the sub-frame transition time has been determined, a comparison can be made between the sub-frame transition time and a duration of a spoke state of a color filter used in the display system (block 615). As discussed previously, the spoke state of the color filter can be used to help alleviate timing uncertainty with respect to exact position of the color filter. If the sub-frame transition time is less than (or substantially equal to) the duration of the spoke state (the spoke time), then the sub-frame transition time can simply be overlapped with the spoke time (block 620) and the sequence of events 600 can end. If the sub-frame transition time can be entirely (or substantially entirely) overlapped with the spoke time, then the sub-frame transition should have no effect on the image quality of the display system since the display system is not displaying any image information while the optical lens is in transition. The sub-frame transition can be initiated at substantially the same time as the spoke state of the color filter begins. Since the sub-frame transition time is shorter than (or substantially equal to) the duration of the spoke state, the sub-frame transition is hidden by the spoke state.

If the sub-frame transition time is greater than the spoke time (block 615), then a percentage of a single color state time that is the difference of the sub-frame transition time and the spoke time is determined (block 625). The determination of the percentage can be expressed as: percentage=(sub_frame_transition_time−spoke_time)/single_color_state_time. The percentage provides an indicator of how much the difference of the sub-frame transition time and the spoke time occupies of a single color state time. Alternatively, the percentage can be computed as a percentage of all state times of a single color within the single frame period. For example, if there are four blue color states within the single period, then the percentage is determined based on a sum of all four color state times. Then, the percentage is compared against a specified threshold (block 630). If the percentage is less than or substantially equal to the specified threshold, then the sub-frame transition can be permitted to overlap the spoke time and a single color state (block 635), as shown in FIG. 4a, and the sequence of events 600 can end. Alternatively, rather than starting the sub-frame transition with the beginning of the spoke state, the sub-frame transition can be started in a color state immediately preceding the spoke state and timed so that the sub-frame transition will end at approximately the same time as the end of the spoke state. With the percentage being less than (or substantially equal) to the specified threshold, the sub-frame transition does not negatively affect more than a prespecified amount of a single color's light in the image being displayed and this prespecified amount has been determined as yielding an acceptable image quality. The sub-frame transition can be initiated at substantially the same time as the start of the spoke state of the color wheel. Since the sub-frame transition is longer than the spoke state, a portion of the sub-frame transition will occur in a color state that immediately follows the spoke state.

If the percentage is greater than the specified threshold (block 630), then the sub-frame transition is configured so that it overlaps the spoke time and two color states (block 640), as shown in FIG. 4a, and the sequence of events 600 can end. With the percentage being more than the specified threshold, the sub-frame transition does negatively affect more than the prespecified amount of a single color's light and the sub-frame transition must be configured to span two color states to mitigate the image degradation. The spanning of two color states can reduce the impact of the image degradation, however, if the sub-frame transition takes too much time, there may still be noticeable image degradation—this time in two colors. The sub-frame transition can be initiated at some point within a color state immediately preceding the spoke state and the sub-frame transition will occur in both the color state immediately preceding the spoke state and the spoke state itself. The initiation time of the sub-frame transition can be selected to that as the spoke state finished, the sub-frame transition will still be occurring. Therefore, the sub-frame transition will also occur in a color state that immediately follows the spoke state.

With reference now to FIG. 7, there is shown a diagram illustrating an algorithm 700 for use in distributing light for display in a single frame of a display system, according to a preferred embodiment of the present invention. According to a preferred embodiment of the present invention, the algorithm 700 can be executed in a sequence controller of the display system. The sequence controller can be responsible for generating light instructions and light modulator instructions, as well as data movement and manipulation instructions, that can be used to display images on a display of the display system. Alternatively, a controller, a general purpose processing element, a special purpose processing element, a custom designed integrated circuit, and so forth, may be used to execute the algorithm 700.

The sequence controller can begin by retrieving the light to be displayed within a single frame by a single light modulator (block 702) and then determining if the light to be displayed is greater than or substantially equal to a minimum amount of light displayable in the single frame (block 705). If light has higher intensity that the minimum displayable amount of light in the single frame, then it can be possible to distribute the light evenly (or relatively evenly) across the sub-frames of the single frame. The sequence controller can then divide the light by the number of sub-frames (block 710). For example, if the amount of light to be displayed is 99 units, then for a four sub-frame frame, the first three sub-frames can each display 25 units of light and the fourth sub-frame can display 24 units of light. The division of the light across the sub-frames can then be followed with the distribution of the divided light values to the sub-frames (block 715). This may be accomplished by storing in a display memory the different light values to be displayed during a single frame period. The display memory may be organized based on individual light modulators.

If the light has an intensity that is less than the minimum displayable amount of light in the single frame (block 705), then it may not be possible to distribute the light across the multiple sub-frames. It may then be necessary to display the light in a single sub-frame (block 720). This can be accomplished by storing the light value in a display memory that is associated with a single sub-frame with the display memory for the other sub-frames storing zero light values. Alternatively, a further distribution of the light can be performed. A second check can be made to determine if the light has an intensity that is less than or substantially equal to a minimum displayable amount of light in a single sub-frame (not shown). If the light is less than or approximately equal in intensity to the minimum amount of light displayable in a single sub-frame, then the light can be assigned to a single sub-frame. If the light has greater intensity than the minimum amount of light displayable in a single sub-frame, then the light can be distributed across the sub-frames in the frame, with the distribution being limited to the minimum displayable amount of light in a single sub-frame. For example, if the light to be displayed has an intensity of nine (9) units and the minimum amount of displayable light in a sub-frame is four (4) units, then for a four sub-frame frame, the light can be distributed as follows: sub-frame one displays four (4) units, sub-frame two displays five (5) units, and sub-frame three and sub-frame four display zero (0) units. When it is time to project the light, the contents of the display memory can then be retrieved and the individual light modulators can be set to a specified state based upon the contents of the display memory.

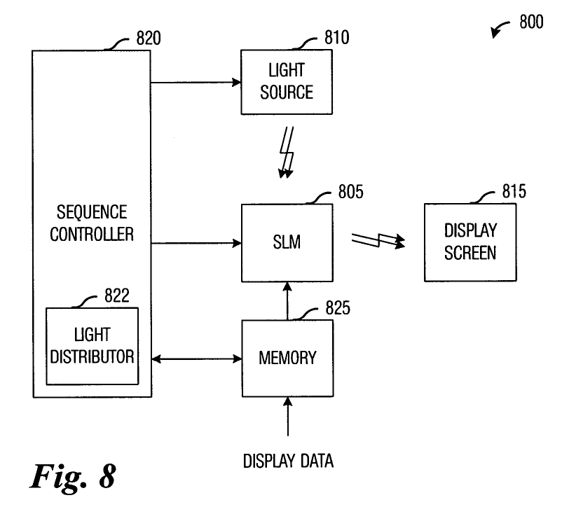

With reference now to FIG. 8, there is shown a diagram illustrating an exemplary display system 800, wherein light distribution takes place to help improve image quality, according to a preferred embodiment of the present invention. The display system 800 uses a spatial light modulator (SLM) 805, such as a digital micromirror device (DMD), to modulate light provided by a light source 810, which can comprise a UHP arc lamp, one or more LEDs, lasers, and so forth. Light reflected from the SLM 805 can be displayed on a display screen 815. A sequence controller 820 can control the operation of the SLM 805, the light source 810, and a memory 825. The memory 825 can buffer image data (such as images to be displayed by the display system 800) that can be provided to the SLM 805. The image data can be used to set the state of light modulators, such as micromirrors in a DMD, in the SLM 805.

The sequence controller 820 can contain a light distributor 822, which can be used to distribute light to be displayed within a single frame period to sub-frames within a single frame to reduce undesired visual effects such as flickering, an unsmooth image, and so forth. The light distributor 822 can retrieve from the memory 825 image data for an image to be displayed and determine an amount of light to be displayed within the single frame for each of the light modulators in the SLM 805. Based upon the light to be displayed, the light distributor 822 can attempt to evenly (or relatively evenly) distribute the light to each of the sub-frames in the single frame. The light distributor 822 may be a software implementation of a light distribution algorithm, such as the algorithm 700 (FIG. 7). Alternatively, the light distributor 822 may be implemented in hardware or firmware. Furthermore, the light distributor 822 may be implemented as a separate integrated circuit external to the sequence controller 820 and coupled in between the sequence controller 820 and the memory 825. For each frame, the light distributor 822 can perform the distribution of light for each component color (typically red, green, and blue) for each light modulator in the SLM 805.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method comprising:
determining a sub-frame transition time;
initiating a sub-frame transition to coincide with a start of a spoke state of a color filter in response to a determination that the sub-frame transition time is less than or substantially equal to a duration of the spoke state; and
spanning the sub-frame transition over the spoke state and a color state of the color filter in response to a determination that the sub-frame transition time is greater than the duration.

2. The method of claim 1, wherein the spanning comprises computing a percentage value, and wherein the percentage value is expressed as:
percentage value=(sub-frame transition time−duration of spoke state)/(duration of color state).

3. The method of claim 2, wherein the spanning further comprises initiating the sub-frame transition to coincide with a start of the spoke state in response to a determination that the percentage value is less than or substantially equal to a specified threshold.

4. The method of claim 2, wherein the spanning further comprises initiating the sub-frame transition in a color state immediately preceding the spoke state in response to a determination that the percentage value is greater than a specified threshold.

5. The method of claim 4, wherein the sub-frame transition is initialized so that the sub-frame transition completes at substantially a same time as an end of the spoke state.

6. The method of claim 2, wherein the spanning comprises initiating the sub-frame transition during a color state immediately preceding the spoke state in response to a determination that the percentage value is greater than the specified threshold, wherein the sub-frame transition continues into a color state immediately succeeding the spoke state.

7. The method of claim 6, wherein the color state immediately preceding the spoke state or the color state immediately succeeding the spoke state is a color that is least visually sensitive to human eyes.

8. The method of claim 7, wherein the sub-frame transition overlaps a larger portion of a color state wherein the color of the color state is less visually sensitive to human eyes.

9. The method of claim 2, wherein the color state time is equal to a sum of color state times of a single color state occurring within a single frame.

10. The method of claim 1, wherein the color state spanned by the sub-frame transition is a color that is least visually sensitive to human eyes.

11. The method of claim 1, wherein there are a plurality of sub-frame transitions in a frame, and wherein the determining, initiating, and spanning is repeated for each sub-frame transition in the frame.

12. A method comprising:
retrieving a light intensity to be display within a frame with a light modulator, wherein the frame comprises a plurality of sub-frames;
assigning the light intensity to a single sub-frame in response to a determination that the light intensity is less than or substantially equal to a minimum displayable amount of light in the frame;
in response to a determination that the light intensity is greater than the minimum displayable amount of light in the frame;
dividing the light intensity by a number of sub-frames in the plurality of sub-frames; and
assigning the divided light intensity to each sub-frame in the plurality of sub-frames.

13. The method of claim 12, wherein an array of light modulators is used to display images, and the method further comprises repeating the retrieving, first assigning, dividing, and second assigning for each modulator in the array.

14. The method of claim 12, wherein the first assigning further comprises assigning a zero light intensity for remaining sub-frames in the frame.

15. The method of claim 12, wherein the first assigning comprises:
assigning the light intensity to a single sub-frame in response to a determination that the light intensity is less than or substantially equal to a minimum displayable amount of light in the single sub-frame;
in response to a determination that the light intensity is greater than the minimum displayable amount of light in the single sub-frame;
dividing the light intensity by a number of sub-frames in the plurality of sub-frames; and
assigning the divided light intensity to each sub-frame in the plurality of sub-frames.

16. The method of claim 15, wherein the second assigning comprises:
assigning the minimum displayable amount of light to a sub-frame if the divided light intensity is less than the minimum displayable amount of light; and
assigning zero light intensity to remaining sub-frames once all of the light intensity has been assigned.

17. A display system comprising:
a display device coupled to a sequence controller and a memory, the display device configured to display image data stored in the memory; and
a light distributor coupled to the sequence controller and the memory, the light distributor configured to distribute a light value to be displayed within a frame substantially evenly across a plurality of sub-frames in the frame, wherein the light value is part of the image data stored in the memory.

18. The display system of claim 17, wherein the display device comprises a plurality of light modulators, wherein for each light modulator in the display device there is a light value for a plurality of color components used in the display system, and wherein the light distributor distributes a light value for each color component of each light modulator.

19. The display system of claim 17 further comprising a display screen coupled to the display device, the display screen to permit viewing of displayed image data.

20. The display system of claim 17, wherein the display device is a spatial light modulator.

21. The display system of claim 20, wherein the display device is a digital micromirror device (DMD).
